(19) United States
(12) Patent Application Publication
(10) Pub. No.: US 2010/0179958 A1
(43) Pub. Date: Jul. 15, 2010

(54) Apparatus, methods, and products for surfing the internet

(76) Inventor: Michael James Carr, Cypress, TX (US)

Correspondence Address: C. DALE QUISENBERRY, 6750 WEST LOOP SOUTH, SUITE 920, BELLAIRE, TX, 77401, US

(21) Appl. No.: 12/374,372

(22) PCT Filed: Jul. 18, 2007
(86) PCT No.: PCT/US07/73748

§ 371 Date: Jan. 19, 2009

Related U.S. Application Data
(60) Provisional application No. 60/807,766, filed on Jul. 19, 2006.

(51) Int. Cl. G06F 17/30

(52) U.S. Cl. 707/758; 707/E17.108; 715/856

(57) ABSTRACT

Various systems, methods and products are provided for surfing the Internet. A method may include positioning a cursor over information to be search (e.g., a word or phrase on a web page, or on a screen, or in an electronic document), and initiating a web search by clicking on or otherwise acting upon the information. A method may also in include selecting information on a web page, clicking on the information as it resides on the web page, and in response to the clicking, conducting a web search on the information. The methods may also include displaying the results of the web search, such as on a computer screen for viewing and, if desired, further searching. A method of executing a web search may include (i) receiving a request to conduct a web search on information, wherein the request was generated by clicking on the information, and (ii) executing a web search on the information. An information handling system may include (a) a processor and (b) software that when executed will allow the system to (i) receive a request to conduct a web search on information, wherein the request was generated by selecting (e.g., highlighting) the information on a web page and clicking on the information, and (ii) execute a web search on the information. Related computer readable media and other methods and systems are also provided.

### BACKGROUND OF THE INVENTION

1. Field of the Invention

The present invention generally pertains to the Internet, and more particularly to apparatus, methods, and products for surfing the Internet.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Surfing the Internet is now a daily part of life for the vast majority of Americans and others around the world. The use of an information handling system optionally in conjunction with a web browser to access content on the Internet is something that is second nature to the technology literate and no doubt happens millions of times per day in the United States and elsewhere around the world. It is not uncommon when reading content (e.g., a news article) on the Internet (sometimes referred to herein as “General Content” information) to encounter a word, name, phrase or other portion of the General Content information that the reader does not understand, and/or as to which the reader has little or no knowledge (sometimes referred to herein as the “Specific Content” information). Many times, the reader is desirous of learning about the Specific Content information before continuing to read the General Content information.

### SUMMARY OF THE INVENTION

Suppose you are reading information on a screen (e.g., the information could be a press release about a new product on a company's web page you are viewing on a computer screen) and you come across a word or phrase that you would like to know more about. As is well known, one way to learn more about the word or phrase is to copy it (e.g., via “cut-and-paste” or “drag-and-drop”), or retype it, into the search field of a search engine (e.g., Google, MSN, Yahoo!, Dogpile, etc.) and then use that search engine to generate a list of results and related links to other web pages having information about the word or phrase being searched. The inventor of the present inventions discovered that it would be great if he could remove the step of manually copying, cutting/pasting, dragging/dropping or retyping the word or phrase into a search field, and instead simply position the cursor over or otherwise select (e.g., highlight) the word or phrase and click or take some action on it, which click or action would cause a web search on the word or phrase to be conducted on a search engine and the search results to be displayed. He could then read and click on those search results to learn more about the word or phrase, and when finished with that research go back to the original page or document where he originally read the word or phrase, and continue reading that page or document. This flash of genius led to the various inventions disclosed and explained below.

According to one embodiment of the present invention, there may be provided a method of surfing the Internet comprising selecting information on a web page; clicking on the information as it resides on the web page; and in response to the clicking, conducting a web search on the information.

According to another embodiment of the present invention, there may be provided a method comprising: clicking on information; and in response to the clicking, conducting a web search on the information.

According to even another embodiment of the present invention, there may be provided a method of surfing the Internet comprising: positioning a cursor over information to be searched; and initiating a web search by clicking on the information.

According to still another embodiment of the present invention, there may be provided a method of surfing the Internet comprising: positioning a cursor sufficiently near information to be searched so as to indicate a selection of the information; and initiating a web search by carrying out an action to initiate a web search.

According to yet another embodiment of the present invention, there may be provided a method of surfing the Internet comprising: selecting information on a web page; requesting a web search on the information as it resides on the web page; and in response to the request, conducting a web search on the information.

According to even still another embodiment of the present invention, there may be provided a method comprising: taking action on information viewable on a display; and in response to the action, conducting a web search on the information.

According to even yet another embodiment of the present invention, there may be provided a method comprising: taking action on information in a window; and in response to the action, conducting a web search on the information.

According to still even another embodiment of the present invention, there may be provided a method of executing a web search comprising: receiving a request to conduct a web search on information, wherein the request was generated by taking action on the information on a web page and clicking on the information; and executing a web search on the information.

According to still yet another embodiment of the present invention, there may be provided a method of executing a web search comprising: receiving a request to conduct a web search on information, wherein the request was generated by selecting the information on a web page and clicking on the information; and executing a web search on the information.

According to yet even another embodiment of the present invention, there may be provided an information handling system for executing a web search comprising: a processor; and software that when executed will allow the system to (i) receive a request to conduct a web search on information, wherein the request was generated by selecting the information on a web page and clicking on the information, and (ii) execute a web search on the information.

According to yet still another embodiment of the present invention, there may be provided an information handling system for carrying out a web search comprising: a processor adapted to (i) receive a request to conduct a web search on information, wherein the request was generated by selecting the information on a web page and clicking on the information, and (ii) execute a web search on the information.

According to even still yet another embodiment of the present invention, there may be provided a computer readable media comprising software that when executed by an information handling system will allow the system to (i) receive a request to conduct a web search on information, wherein the request was generated by selecting the information on a web page and clicking on the information, and (ii) execute a web search on the information.

According to even yet still another embodiment of the present invention, there is provided an information handling system for executing a web search comprising: a processor; and software that when executed will allow the system to (i) receive a request to conduct a web search on information, wherein the request was generated by taking action on the information on a web page, and (ii) execute a web search on the information.

According to still even yet another embodiment of the present invention, there may be provided an information handling system for carrying out a web search comprising: a processor adapted to (i) receive a request to conduct a web search on information, wherein the request was generated by taking action on the information on a web page and (ii) execute a web search on the information.

According to still yet even another embodiment of the present invention, there may be provided a computer readable media comprising software that when executed by an information handling system will allow the system to (i) receive a request to conduct a web search on information, wherein the request was generated by taking action on the information on a web page, and (ii) execute a web search on the information.

According yet even still to another embodiment of the present invention, there is provided a method of surfing the Internet comprising: giving a voice command to identify the information on which a web search is desired; and giving a voice command to initiate a web search on the information.

Further embodiments of the above embodiments may include any one or more of the following: (1) wherein the information is selected from the group consisting of any one or more of a number, a character, a symbol, a word fragment, a word, a partial phrase, a phrase, a name, a partial title, a title, a partial sentence, a sentence, a partial paragraph, a paragraph, an icon, a graphic image, a music clip, and a video clip; (2) further comprising displaying search results generated by the web search; (3) wherein the information is displayed in a first window and the search results are displayed in a second window; (4) wherein the information is contained in a first web browser, and the search results are contained in a second web browser; (5) wherein the information is viewable in a first web browser, and the search results are viewable in a second web browser; (6) wherein the information and the search results are viewable at the same time; (7) wherein the search results are displayed on a screen; and/or (8) wherein the screen is a computer screen. Other features, aspects and advantages of the present invention will become apparent from the following discussion.

### BRIEF DESCRIPTION OF THE DRAWINGS

FIG. 1 shows page 1 of an article on www.cnn.com.

FIG. 2 shows page 1 of search results conducted on www.google.com on a name that appears in the article shown in FIG. 1.

FIG. 3, is a schematic representation of one embodiment of a method 50, that may include a selecting step 51, a requesting step 52, and a searching step 53.

FIG. 4 is a schematic representation of one embodiment of a method 100, that may include a selecting step 101, a clicking step 102, and a searching step 103.

FIG. 5 is a schematic representation of another specific embodiment of a method 150 that may include a cursor positioning step 152 and a searching step 154.

FIG. 6 is a schematic representation of Internet 24 having connected thereto a user 21, a search engine host 22, and a web page host 27.

FIGS. 7A, 7B and 7C are non-limiting illustrations of how search results 401 may be displayed on a screen 400, such as over a General Content window 402, beside window 402 or as a bubble within window 402.

FIG. 8 is a flowchart of a method 450 for executing a search, which may include a receive request step 452 and an execute web search step 454.

FIG. 9 is a schematic representation of an information handling system (IHS) 500 that may include a processor 502, software 504, an incoming request 507 and outgoing search results 509.

While the invention will be described in connection with the preferred embodiments, it will be understood that it is not intended to limit the invention to those embodiments. On the contrary, it is intended to cover all alternatives, modifications, and equivalents as may be included within the spirit and scope of the invention as defined by the appended claims.

### DETAILED DESCRIPTION

For purposes of this patent, an information handling system (IHS) may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, read only memory (ROM), and/or other types of nonvolatile memory. Additional components of the information handling system may include one or more disk drives, one or more network ports for communicating with external devices, and various input and output (I/O) devices, such as a keyboard, a mouse, and a video display. The information handling system may also include one or more buses and/or interfaces and related software operable to transmit communications between the various hardware components and/or over the Internet.

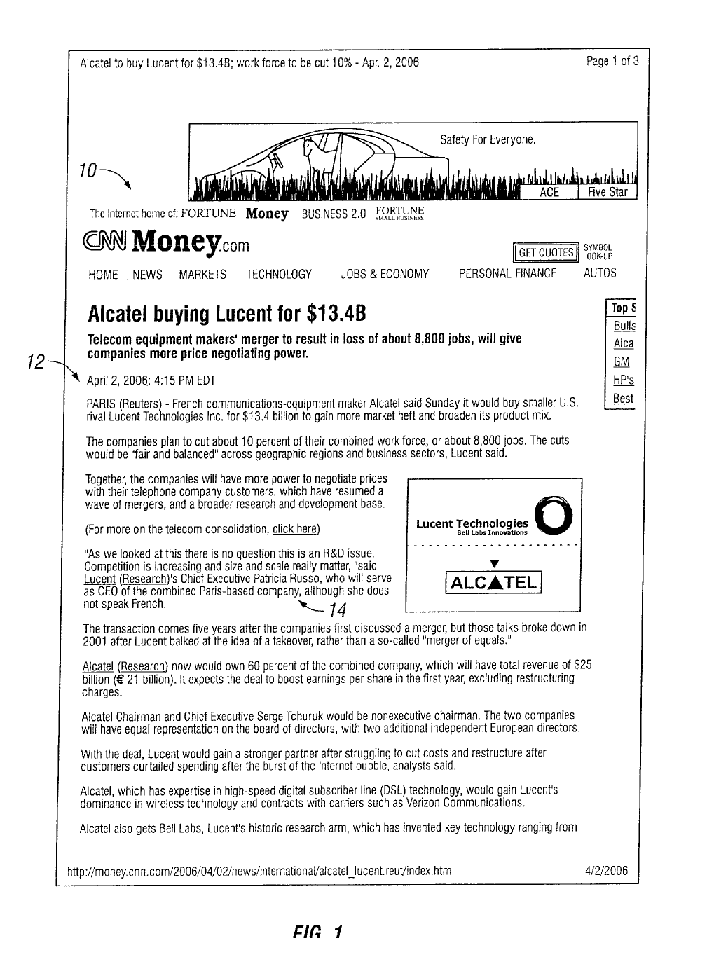

Referring to the drawings in detail, wherein like numerals denote identical elements throughout the several views, there is shown in FIG. 1 a sample web page 10 containing information referred to as a body of General Content information 12. For purposes of this invention, the phrase “General Content” means any type of information searchable by a search engine, non-limiting examples of which include information comprising a number, character, symbol, word fragment, word, partial phrase, phrase, name, partial title, title, partial sentence, sentence, partial paragraph, paragraph, icon, graphic image, music clip, video clip, more than one of any of the foregoing, and/or combinations of the foregoing. The terms “character” and “symbol” should be broadly interpreted and include at least ASCII, multinational, phonetic, typographic, iconic, math, and scientific characters and symbols and writing characters of any language. Further non-limiting examples of General Content information may comprise: a single word, number or character on a web page; a phrase of two words or more on a web page; a single sentence; a paragraph including two or more sentences; two or more paragraphs; and a combination of one or more words, numbers and/or characters. As additional non-limiting examples, the General Content information may comprise text, numbers or characters of any type, including but not limited to: a news article; an entire web page; an advertisement on the web site of a business; an on-line book; a magazine article; or any other electronic document whether or not on the Internet, including any document or text stored on a hard drive or viewable on a screen.

By way of illustration only, and without limiting the scope of the present invention to this specific example, referring now to the web page shown in FIG. 1, in a specific embodiment the General Content information 12 may be a news article found at www.cnn.com. Or it may be a single paragraph within the article. For example, the General Content information may comprise the following paragraph contained in the article:
‘As we looked at this there is no question this is an R&D issue. Competition is increasing and size and scale really matter,’ said Lucent (Research)'s Chief Executive Patricia Russo, who will serve as CEO of the combined Paris-based company, although she does not speak French.

Suppose that the reader is reading through this General Content information and stops when the reader comes to the name “Patricia Russo” because the reader would like to know more about her. For purposes of this example, the name “Patricia Russo” comprises Specific Content information 14. For purposes of the present invention, the phrase “Specific Content” information refers to any part of or all of the General Content information, that the reader desires to research.

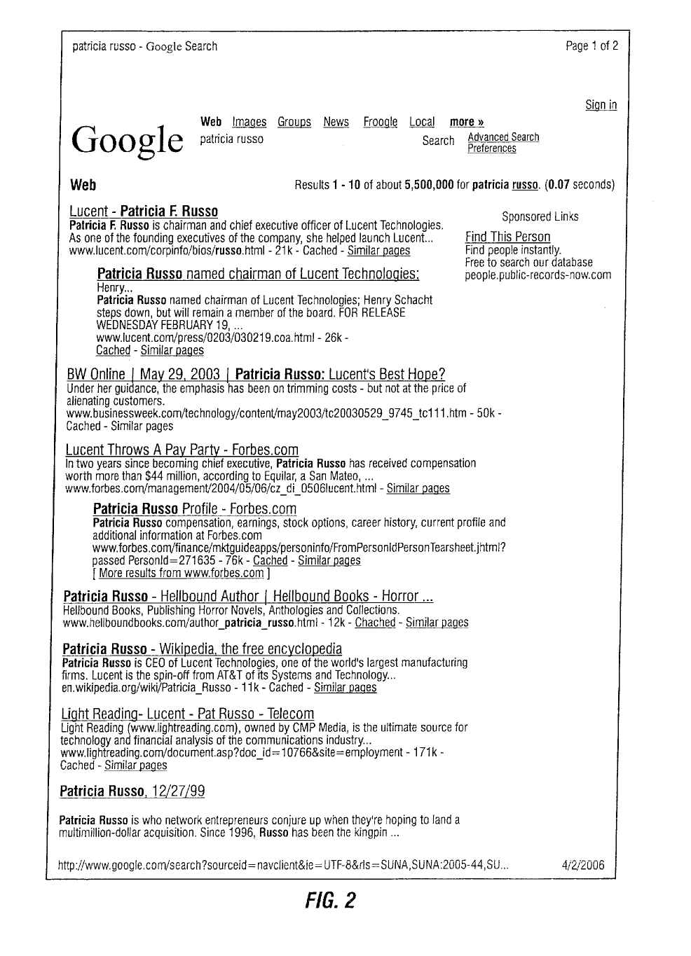

For example, when the reader stops at the name “Patricia Russo” and wishes to learn more about that person, heretofore, the reader might have opened another window with the web browser, found a search engine (i.e., Google, Dogpile, MSN, etc.), and cut and pasted (or drag and dropped) the name “Patricia Russo” into the search field of the search engine. As is well known, the search engine will pull up one or more pages containing a variety of links the reader could click on to learn about the Specific Content information. In this specific example, if the search is conducted on Google, the first page of the search results is illustrated in FIG. 2. Some of the links pulled up by the search engine will be more relevant than others.

In a more streamlined version, many search engines, Google for example, provide a search tool bar that may be made resident on the web page the reader is viewing. However, such a tool bar still requires that the target word/phrase (i.e, Specific Content information) be retyped, copied or drag and dropped, into a search field.

The present invention is directed to a system and method for expediting this search process.

Under a specific embodiment of the present invention, the reader may select the Specific Content information (i.e., the name “Patricia Russo”) for which more information is sought, and then take a predetermined action or actions which will execute a web search on the Specific Content information in situ. By in situ, it is meant that the search is executed on the Specific Content information from where it originally sits within the General Content information, without having to manually copy, type, or drag-and-drop, the Specific Content information into a search engine search field.

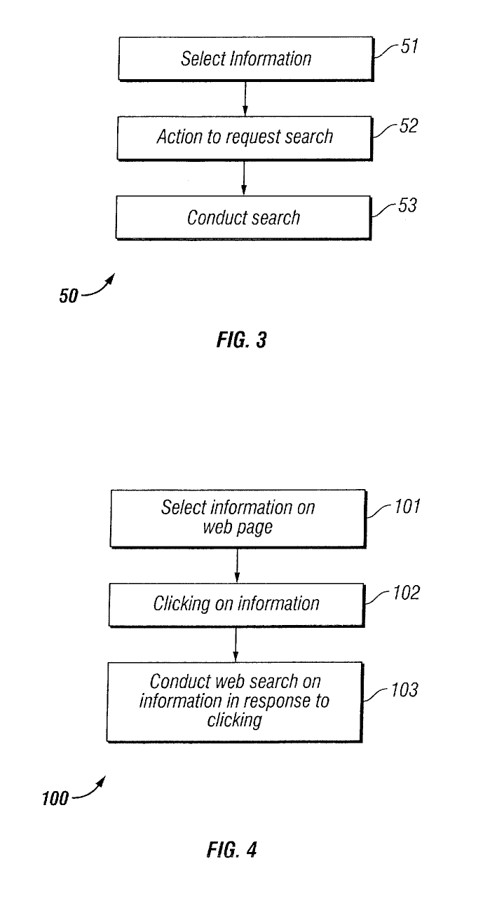

Referring now to FIG. 3, there is shown a generic schematic representation of one embodiment of a method 50, which may include one or more of a selecting step 51, a requesting step 52, and a searching step 53. Step 51 includes selecting the information of interest on the web page or window. Step 52 includes taking predetermined action to request a search on the selected information. The predetermined action will execute a web search on the selected information, without the need to manually copy, type or drag-and-drop the information into a search engine field. Step 53 includes conducting a web search on the selected information.

In a more specific non-limiting embodiment, FIG. 4 shows a schematic representation of a method 100, which may include one or more of a selecting step 101, a clicking step 102, and a searching step 103.

It should be understood that for purposes of the present invention information may be selected by a wide variety of methods. For example, commonly, PC and Mac programs provide for text to be selected by highlighting the text, which highlighted text may then be subjected to an operation, for example, copied, moved, deleted, underlined, bolded, italicized, font change, font size change, and drag-and-dropped. The present invention may utilize any available method of selecting text.

In such programs, this selecting may be carried out by using the mouse, or even by using the keyboard arrow keys. To select text with a mouse, position the curser at one end of the text to be selected. Press and hold down the mouse button, drag to the other end of the text, and then release the mouse button. In many programs, double clicks will select a word, and triple clicks will select a sentence or paragraph. To select text with the keyboard arrow keys, position the curser at one end of the text to be selected. Click the mouse button one time, and then holding down the shift key, use the arrow keys to position the curser at the other end of the text to be selected.

For purposes of the present invention, the phrases “click,” “clicks,” “click on,” “clicks on” or “clicking” means any way that the user of an IHS may send a signal to the IHS with a mouse, mouse pad, roller ball or other such I/O device to request that the requested operation be performed by the IHS (e.g., single click on the left or right mouse button, double click on the left or right mouse button, single or double tap on a mouse pad, hit the “Enter” key, etc.).

It should be understood that a selection may be made by any prearranged form of instruction to the IHS, including but not limited to, any keyboard command or input, any mouse command or input, a click, a double click, one or more keystrokes, any audio input, any voice command, any IR input, any digital pen input, any roller ball input, any light input, any joy stick input, any touch pad input, any touch screen input, clicking any icon, any hot key input, any function key input, and any combinations or sequences of any one or more of these, or any other means of sending a signal to a computer or similar device to cause the computer or device to take action.

As still another non-limiting example, a selection may be made by use of a hot-key or keys so programmed. As yet another non-limiting example, a selection may be made by use of audio commands. As even still another non-limiting example, a selection may be made by using a digital pen, i.e., by highlighting, pointing to, or circling.

Once information is selected, a search is then executed on the selected text without the need to copy, type, or drag-and-drop the information into a search engine search field.

Under one non-limiting embodiment of the present invention, once the information has been selected, the user takes an action or actions (e.g., step 52 of FIG. 3) on the selected information to execute software with which the selected information is then made the subject of a search engine search, without the need to manually open a second web page, or manually provide the designated information in a search engine search field. The web site or web page that the reader is viewing is directly or indirectly provided with, or linked to, software that will automatically run a web search of the Specific Content on a previously-selected search engine and pull up the results page (i.e., FIG. 2) when the reader takes the action or actions.

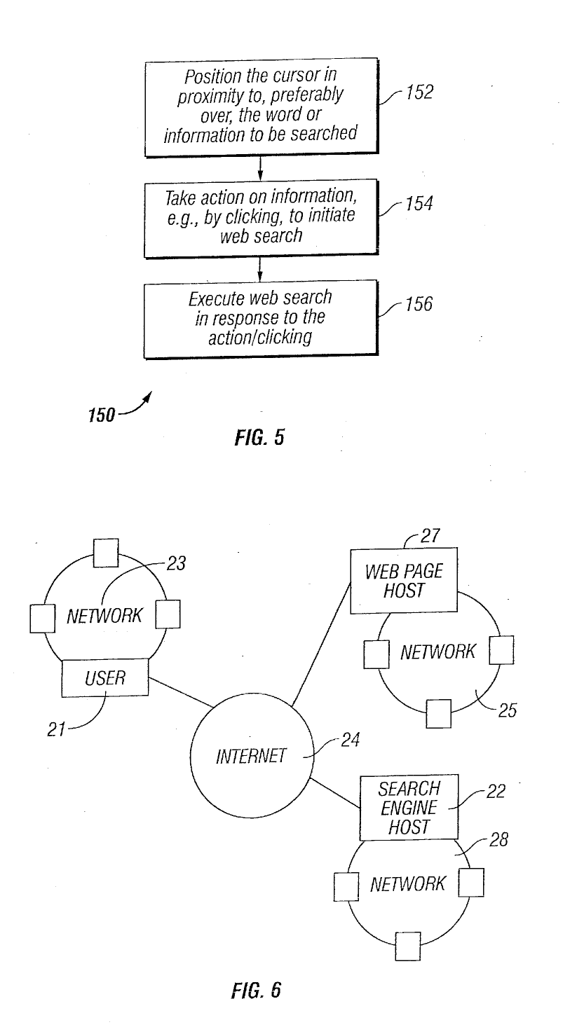

As a non-limiting example, the information to be searched may be selected or designated by simply positioning the cursor in proximity to, preferably over, the word or information to be searched, without manually highlighting it. For example, as shown in FIG. 5, a specific embodiment of a method 150 of the present invention may include a cursor positioning step 152, a web search initiating step 154, and an execute web search step 156. In a specific embodiment, the web search initiating web 154 may comprise clicking on the Specific Content information. In another specific embodiment of the present invention, wherein the information to be searched is contained within a web page, the web page may be provided with software that will conduct a web search on the word over which the cursor is positioned when the click occurs. Alternatively, the software may automatically highlight the word over which the cursor is positioned or positioned most near. In this alternative embodiment, for example, as the user moves the cursor around on the screen the words being highlighted would change according to the position of the cursor at any given moment.

While the action(s) to select the information and the action(s) to execute software to conduct a search are shown as being two different actions, in certain embodiments, it is envisioned that one action or actions(s) may both select the information and execute the search. As a non-limiting example, merely clicking on a word may both select it and execute the search request.

The action or actions to execute software to conduct a web search on the selected information in situ, may be any action suitable to communicate with an IHS as described above for selecting information, including but not limited to, any keyboard command or input, any mouse command or input, a click, a double click, one or more keystrokes, any audio input, any voice command, any IR input, any digital pen input, any roller ball input, any light input, any joy stick input, any touch pad input, any touch screen input, clicking any icon, any hot key input, any function key input, and any combinations or sequences of any one or more of these, or any other means of sending a signal to a computer or similar device to cause the computer or device to take action.

In a specific non-limiting embodiment, as illustrated for example in FIG. 6, this software to automatically run a web search can reside locally on a user's computer 21, on a network 23 to which the user belongs, on a computer 27 on the web page host's network 25, or on a computer 22 on the search engine host's network 28 or at any other suitable location. The software may be remotely initiated through the use of the Internet 24. In addition, portions of the software may be distributed on any two or more computers.

The software may be operable from any window, whether of a site on the Internet, or of a window of any program, non-limiting examples of which include word processing software such as Word or WordPerfect, spread sheet software, accounting software, email software, web browser, as well as others.

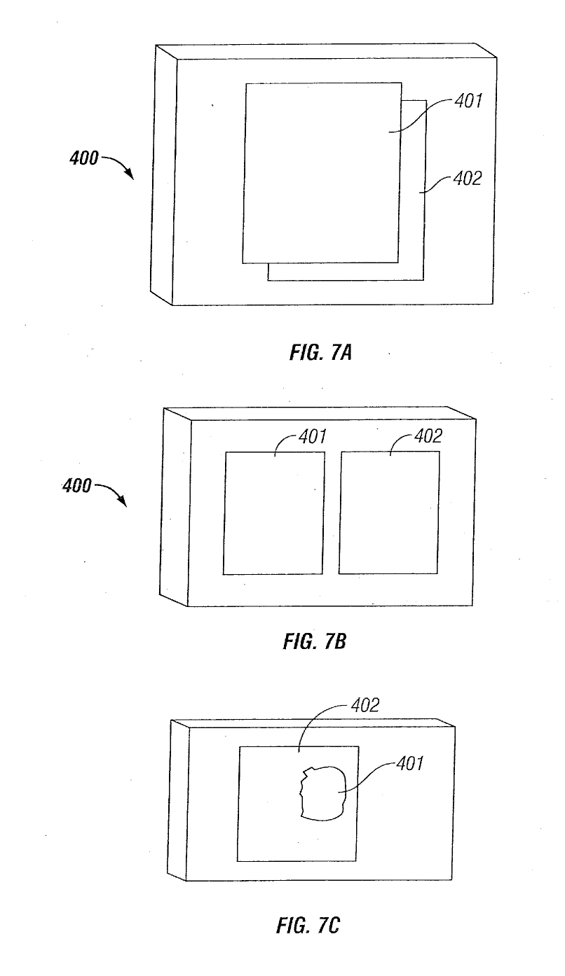

As an example of the software being operable from the web page, in the example discussed above, suppose that CNN has implemented the present invention on its web site pursuant to an agreement with Google. In this specific embodiment, the reader would highlight the name “Patricia Russo” and initiate the search in situ by providing the requisite action, non-limiting examples include hitting the appropriate key on a keyboard or clicking the appropriate button on a mouse or mouse pad, as discussed above, and the search results page as shown in FIG. 2 would be automatically displayed, for example, either as a full screen window 401 on screen 400 which fully covers the prior content window 402 (see FIG. 7A), a screen behind the prior content, a screen 401 side-by-side with the prior content 402 (see FIG. 7B), or as a partial window or bubble 401 (FIG. 7C). The reader may then click on any one or more of those links and conduct research concerning the Specific Content until the reader is ready to return to the General Content which is preferably still available in an active window. It should be understood that the present invention may be carried out in a search result window to open even further search windows.

As an example of the software being operable from the local computer, in the example discussed above, software would be operable in conjunction with the operating web browser, or operable as part of a keyboard macro or program. In a specific embodiment, the reader would highlight the name “Patricia Russo” and initiate the search by hitting the appropriate key on a keyboard or clicking the appropriate button on a mouse or mouse pad, as discussed above, and the search results page as shown in FIG. 2 would be automatically displayed.

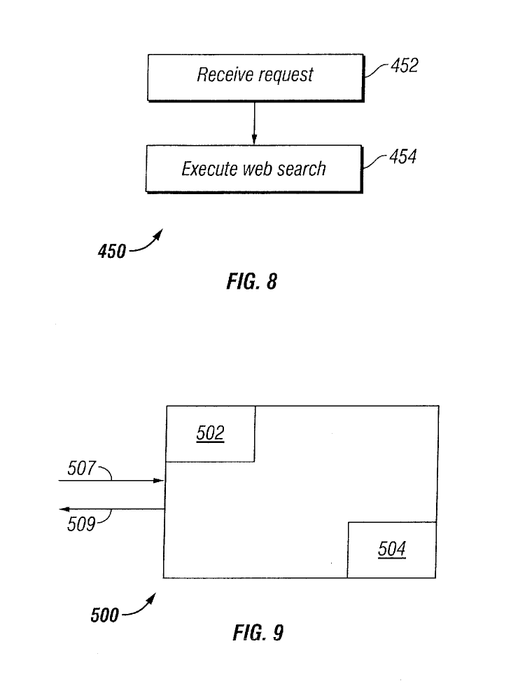

A web search operator, such as Google, Yahoo, Dogpile, and the like, could implement the present invention, to carry out the invention. Referring now to FIG. 8 there is shown a flowchart of a method 450 for executing a search, which in a specific embodiment may include a receive request step 452 and an execute web search step 454.

One or more of the steps of the various method embodiments of the present invention may be embodied in computer readable media comprising software that when executed on an IHS will carry out the step(s). Further, one or more of the steps of the various method embodiments of the present invention may be embodied in a signal wave or digital signal that when executed on an IHS will carry out the step(s).

It is believed that the present invention may be carried out on any suitable IHS. Referring now to FIG. 9, there is shown a schematic representation of one non-limiting example of an information handling system (IHS) 500 suitable for carrying out the present invention that may include a processor 502, software 504, an incoming request 507 and outgoing search results 509.

It is to be understood that the invention is not limited to the exact details of construction, operation, exact materials or embodiments shown and described, as obvious modifications and equivalents will be apparent to one skilled in the art. Accordingly, the invention is therefore to be limited only by the scope of the appended claims.

1. A method of surfing the Internet comprising:
a. selecting information on a web page;
b. clicking on the information as it resides on the web page; and
c. in response to the clicking, conducting a web search on the information.

2. The method of claim 1, wherein the information is selected from the group consisting of any one or more of a number, a character, a symbol, a word fragment, a word, a partial phrase, a phrase, a name, a partial title, a title, a partial sentence, a sentence, a partial paragraph, a paragraph, an icon, a graphic image, a music clip, and a video clip.

3. The method of claim 1, further comprising displaying search results generated by the web search.

4. The method of claim 3, wherein the information is displayed in a first window and the search results are displayed in a second window.

5. The method of claim 3, wherein the information is contained in a first web browser, and the search results are contained in a second web browser.

6. The method of claim 3, wherein the information is viewable in a first web browser, and the search results are viewable in a second web browser.

7. The method of claim 3, wherein the information and the search results are viewable at the same time.

8. The method of claim 3, wherein the search results are displayed on a screen.

9. The method of claim 8, wherein the screen is a computer screen.

10. A method comprising:
a. clicking on information; and
b. in response to the clicking, conducting a web search on the information.

11. The method of claim 11, wherein the information is viewable on a display.

12. The method of claim 11, wherein the information is viewable in a window.

13. The method of claim 11, wherein the information is selected from the group consisting of any one or more of a number, a character, a symbol, a word fragment, a word, a partial phrase, a phrase, a name, a partial title, a title, a partial sentence, a sentence, a partial paragraph, a paragraph, an icon, a graphic image, a music clip, and a video clip.

14. A method of surfing the Internet comprising:
a. positioning a cursor over information to be searched; and
b. initiating a web search by clicking on the information.

15. The method of claim 15, further comprising displaying the results of the web search.

16. The method of claim 15, further comprising highlighting the information before positioning the cursor over the information.

17. The method of claim 15, wherein the information is selected from the group consisting of any one or more of a number, a character, a symbol, a word fragment, a word, a partial phrase, a phrase, a name, a partial title, a title, a partial sentence, a sentence, a partial paragraph, a paragraph, an icon, a graphic image, a music clip, and a video clip.

18. The method of claim 15, wherein the information is on a web page.

19. The method of claim 15, wherein the information is in an electronic document that is not on the Internet.

20-41. (canceled)
